(19) United States
(12) Patent Application Publication
(10) Pub. No.: US 2003/0059756 A1
(43) Pub. Date: Mar. 27, 2003

(54) Neutronic periodic table of the elements with neutronic schema device

(76) Inventor: Charles William Johnson, Jefferson, LA (US)

Correspondence Address: Charles William Johnson, 360 Jefferson Heights Avenue, Jefferson, LA, 70121, US

(21) Appl. No.: 10/198,441

(22) Filed: Jul. 17, 2002

Related U.S. Application Data
(60) Provisional application No. 60/307,319, filed on Jul. 24, 2001.

(51) Int. Cl. G09B 23/26

(52) U.S. Cl. 434/282

(57) ABSTRACT

A Neutronic Periodic Table of the Elements with Neutronic Schema Device presents an apparatus for the physical and visual processing and displaying of quantitative and qualitative data from physics and chemistry in accordance with the neutronic configuration, nucleonic equilibrium and inequality and, the neutronic periodicity of the elements and their atoms. The first twenty representative elements of the periodic table serve as the baseline as of their protonic, electronic and neutronic counts for the schematic creation and improvement of the neutronic periodic table of the elements. The first twenty representative elements consist of elements that have the same or different number of corresponding protons and neutrons in their respective nucleus. The baseline of the neutronic periodic table of the elements is comprised of nine elements within the first twenty representative elements that have the same number of corresponding protons and neutrons in their nucleus, and establish a set of distinctive patterns of symmetry of nucleonic equilibrium, along with the remaining eleven elements that have an unequal number of corresponding protons and neutrons in their nuclear composition, which establish other patterns of asymmetry of nucleonic inequality. The definite patterns of neutronic configuration, nucleonic equilibrium and inequality, and the neutronic periodicity determine certain characteristics and properties of the elements, which are distinct from the classical determinations held to be due to the protonic and electronic counts of the elements and their atoms. The conventional periodic table is based upon the electronic configuration of the elements, whereas the creation and the improvement effected by the neutronic periodic table and its corresponding neutronic schemata are based mainly upon the neutronic configuration, nucleonic equilibrium and nucleonic inequality, and neutronic periodicity of the elements and their atoms.

### CROSS REFERENCE TO RELATED APPLICATIONS

I hereby claim the benefit under 35 USC 119(e) of the U.S. provisional applications listed here:

Provisional Utility Patent Application No. 60/307,319

Original Filing Date of Provisional Application: Jul. 24,2001

### STATEMENT REGARDING FEDERALLY SPONSORED RESEARCH OR DEVELOPMENT

“Not Applicable”

### REFERENCE TO A MICROFICHE APPENDIX

“Not Applicable”

### BACKGROUND TO THE INVENTION

The conventional periodic table of the elements first appeared in relationship to the atomic weight of the elements. However, today's conventional periodic table of the elements is based upon the atomic number of the elements, given their progrssively sequential nature. The progression of the electronic configuration of the atoms has often been referred to in the past as the aufbau design, although this cibceot is enphasized less in the literature today. The conventional periodic table of the elements of today generally violates the progressive sequence of the atomic number of the elements, since the format and presentation of the periodic table in use today, presents the Lanthanide and the Actinide series of elements outside of the main body of the table, making it difficult to visualize relationships among the Lanthanide and the Actinide serties with regard to the representative elements.

The traditional periodic table generally presents various options in displaying a chemical table: one that reflects the valence of elements; a second table of the electronic configuration in order to see the relationship of the elements with their atimic structure; and, a third table of shells and subshells regarding the dependency of the periods in this respect. The conventional periodic table and the electronic schemata of the elements essentially reflect the protonic and electronic aspects of the elements and their atoms.

The conventional periodic table is often referred to as the electronic periodic table of the elements, where the atomic number reflects equal numbers of protons and electrons corresponding to each of the elements and their atoms. The aspect of the neutronic count, the number of neutrons in a particular element, is generally absent from any treatment of the periodic table of the elements in textbooks on chemistry and physics. When the neutronic count is treated in the literature, it is generally on a separate table called the table of isotopes or the table of nuclides. However, the table of nuclides has a very limited use, without being considered an actual periodic table of the elements.

The number of neutrons that are to be found in any given element or atom, does not appear to represent an apparent aufbau or numerically progressive series, as occurs in the protonic and electronic counts of the atoms. The number of neutrons assigned to the elements appears to reflect a tendency towards the progression in the number of neutrons from one element to another. The sequential progression of the number of neutrons in the elements, however, is not cited as reflecting any apparent periodicity as in the periodicity of the electronic configuration of the elements. The neutronic count is generally held to be more random and less predictive than the numbers of protons and electrons in each atom, since the protonic and electronic counts are equal for each atom, and thus more predictable in that sense.

My invention, the neutronic periodic table of the elements is based upon the concept of neutronic periodicity and nucleonic equilibrium, as explained in this patent application, whereby physical and chemical data are processed and displayed both physically and visually in quantitative and qualitative data statements, that illustrate the fact that the neutronic periodicity of the elements and their nucleonic equilibrium or inequality determine some of the characteristics and properties of the elements, thereby consitituting the predictive composition of the neutron count of the elements and their

The number of neutrons in a particular element or atom may vary thereby creating different isotopes, as commonly illustrated on the table of nuclides, where the protonic and electronic numbers remain the same, respectively for each element. The variation in the neutronic count has contributed to the fact that there never has been a neutronic periodic table of the elements. The table of the isotopes or nuclides does not reference the neutronic periodicity of the elements, and therefore fails to tell the whole story regarding the progressive, sequential nature of the neutronic configuration within the elements, and the role of the neutron in determining some of the characteristics and properties of the elements.

From our studies of the electronic schemata of the elements, and the multitude of patterns derived thereof, we have invented A Neutronic Periodic Table of the Elements with Neutronic Schema Device, based upon the neutronic periodicity of the elements and the parallel concept of nucleonic equilibrium. The fact of protonic periodicity of the elements is established by the atomic number registered on the conventional periodic table, and the concept of electronic periodicity or that of the electronic configuration of the elements, establishes the nature of the conventional periodic table. It is generally held that the electronic configuration alone determines the characteristics and the properties of the elements.

Given the nature of the atom, there also exists a neutronic periodicity with specific periodic spacings for every twenty elements with respect to the neutron count of the elements and their atoms. Just as there exist groups and families of elements based upon the protonic and electronic periodicity, there also exist groups of elements formed upon the neutronic periodicity. As we shall observe below, the neutronic groups consist of elements whose atomic numbers end in the same numerical value which occur every twenty elements. The neutronic periodicity better exemplifies and illustrates certain relationships among the elements and their atoms, that the conventional electronic periodic table is unable to illustrate due to its design. The proposal of the neutronic periodicity of the elements improves upon the limited view of basing the entire periodic table only upon the electronic configuration of the elements.

The conventional periodic table represents the protonic and electronic periodicities regarding the s, p, d, f blocks of elements according to the different families and groups. Furthermore, the electronic schemata of the elements, which we have presented as an alternative device to the conventional periodic table, in our patent application No. 09/900,670, present a more effective ordering of the electronic periodicity. Now, with our current invention of the neutronic schemata of the elements and the neutronic periodic table of the elements contained in this invention, sub-groups of elements and their corresponding patterns are created as of the neutronic count of the elements and the concept of nucleonic equilibrium.

The neutronic schemata, the object of this patent application, reflect an orignal concept of neutronic periodicity and nucleonic equilibrium and, require their own distinct and original schematic device completely different from that of the electronic schemata presented by us in a previous invention of the electronic schemata of the elements in patent application Ser. No. 09/900,670. Now, both the electronic schemata and the neutronic schemata are complementary to one another, just as the electronic periodic table and the neutronic periodic table of the elements reflect different aspects of the same physical and chemical phenomenon, that of the existence of the proton, electron, neutron composition of the elements and their atoms.

The neutronic periodic table of the elements and its corresponding neutronic schema device, which are the object of this patent application, comprise the manner in which the neutron count of the elements determines the characteristics and properties of the elements, which may be physically and visually processed and displayed according to the quantitative and qualitative data of physics and chemistry.

1. Field of Invention

My invention, A Neutronic Periodic Table of the Elements with Neutronic Schema Device, creates a visual and physical schema device, that displays the elements of the periodic table in twenty different groups of elemental sectors, listed by a minimum of six rows and twenty columns of elements, processing and presenting chemical and physical data in patterns of symmetry and asymmetry based upon the neutronic configuration, neutronic periodicity and, on the nucleonic equilibrium of the first twenty elements. My invention belongs to Class 434, Education and Demonstration Section I of the corresponding class definition, which is the generic class for apparatus and processes not elsewhere classifiable for, providing instruction about a subject or means and for displaying for purpose of comparison contrast, or demonstration; demonstrating the characteristics and advantages of apparatus, objects, or processes. The subclass of my invention corresponds to subclass 276, Science, the subject-matter relating to the systematic study of matter, energy, and their interrelations and transformations, as well as to the objectively measurable phenomena of nature.

2. Background Art

Description of Related Art Including Information Disclosed Under 37 CFR 1.97 and 37 CFR 1.98

This patent application of my invention, the neutronic periodic table of the elements with neutronic schema device, finds background art in a previous patent application Ser. No. 09/900,670 of my invention of the electronic schemata of the elements. The distinction is significant in that the invention of the neutronic periodic is based upon the neutron count and a completely distinct basic 6×20 grid device based on a structure of elemental sectors, while the electronic schemata of the elements are based on a distinct basic 8×20 grid device of elemental sectors, whereby the neutronic periodic table employs the neutron count and the corresponding concepts of neutronic periodicity and neutronic equilibrium for its reasoning in processing and displaying the data sets, whereas the electronic schemata of the elements follow the electronic configuration of the elements for its improvement upon the conventional periodic table of the elements. The neutronic periodic table of the elements represents an entirely original creation of a way of viewing, processing and displaying the indicia of the elements, while the electronic schemata represent an original creation and improvement of viewing, processing and displaying the indicia of the elements.

Prior representations of the periodic table of the elements may be viewed in a classical text on the history of the periodic table by, professor Edward G. Mazurs, Graphic Representations of the Periodic System During One Hundred Years, The University of Alabama Press, University, Alabama, 1957, 251+ pages, ISBN 0-8173-3200-6. Professor Mazurs explains in great detail the composition and functioning of the proficiencies and deficiencies in the elaboration of the periodic table of the elements ever since its inception by Luois Bernard Guyton (table of 1782). The traditional periodic table of the elements in use today, is based mainly on the concept of Dimitri Mendeleev (tables of 1869 and 1870) and Arthur A. Blanchard (table of 1895), whereby the elements are divided into the s, p, d, and f blocks of elements. The block-like format of the traditional periodic table offers insight into the electronic configuration and relationships of the elements within the specific block arrays. The deficiencies of the block-like format of the traditional periodic table of the elements concern the general impossibility of being able to relate the transition elements, especially the Lanthanide and the Actinide series, with the representative elements on the table.

On the conventional periodic table now in use today throughout the fields of physics and chemistry, the Lanthanide and the Actinide series are placed in the f-block section below the main body of the periodic table of the elements, in a random fashion, completely separate from the s, p, and d blocks of elements, without any recognized criterion for their placement. Mendeleev's 1870 table, a Type IC2-1 table according to professor Mazurs, was the basis for the chart of the atomic elements for many years, until finally the block-design of the Blanchard, a Type IC1-2 table, with certain modifications, has come to be the dominant form of the traditional periodic table of the elements. A similar table that is now in common use is that of Alfred Werner, a Type IIIC3-4 table, according to professor Mazurs, which is often referred to as the “long table”, which consists of enormous gaps between the representative elements, inasmuch as its design incorporates the Lanthanide and the Actinide series into the main body of the traditional Mendeleev and Blanchard tables. Aside from the hundreds of different variations on the traditional periodic table over the past one hundred and thirty years or more, the conventional periodic table essentially contradicts the progressive sequential atomic numbers of the elements in a single format, by creating enormous gaps between the representative elements and the transition elements. The fact that the traditional periodic table of the elements presents a format design based upon the dismemberment of the different (s, p. d, f) blocks explains in part the absence of any significant physical or visual patterns of symmetry concerning the possibility that the neutronic count may also account for determining some of the characteristics and properties of the elements.

The traditional periodic table of the elements, commonly based upon the electronic configuration held to be the determining factor in producing the characteristics and properties of the elements, shows an almost total absence of any reference to the number of neutrons in a given element, in terms of them representing any kind of determination of the characteristics and properties of the elements. The block-like format of the traditional periodic table denies any possibility of perceiving the concept of neutronic periodicity, which is based upon the arrays of elements as created and explained in my invention of the neutronic periodic table, which substantiates the very concept of nucleonic equilibrium and the neutronic schema device for processing and displaying physical an chemical data.

The traditional table of the isotopes, which is commonly used today, represents an attempt to account for the change in the number of neutrons within specific elements of the same atomic number and electronic configuration, but the table of nuclides ignores the kinds of patterns and relationships identified on the neutronic periodic table of the elements. The very absence of meaningful patterns of the kinds that are produced and displayed by the neutronic periodic table and its schema device confirms the deficiency of the table of isotopes in being able to account for neutronic periodicity and nucleonic equilibrium, themes which in fact are absent from any and all tables of the isotopes, as well as from the conventional periodic table of the elements.

### REFERENCES

U.S. Patent Documents

REFERENCES
U.S. PATENT DOCUMENTS
Utility Patents Background Documents:

| | | | |
|---|---|---|---|
| 660,255 | October, 1900 | Kingma | 434/185 |
| 1,087,336 | February, 1914 | Thurber | 434/430 |
| 1,590,998 | June, 1926 | Balston | 400/99 |
| 2,052,457 | August, 1936 | French | 434/278 |
| 2,085,881 | July, 1937 | Van Doren | 434/278 |
| 2,516,418 | July, 1950 | Ramsay | 434/281 |
| 2,651,115 | September, 1953 | Davies | 434/281 |
| 2,891,322 | June, 1959 | Brownlee | 434/282 |
| 2,920,401 | January, 1960 | Lennon | 434/281 |
| 3,156,985 | September 1964 | Bliss, et.al. | 434/282 |
| 3,183,608 | May, 1965 | Jierree | 434/278 |
| 3,325,914 | June, 1967 | Bliss, et.al. | 434/278 |
| 3,390,468 | July, 1968 | Mitchell | 434/282 |
| 3,406,972 | October, 1968 | Wong | 273/118A |
| 3,654,708 | April, 1972, | Brudner | 434/307 |
| 3,866,337 | February, 1975 | Burns | 434/281 |
| 4,193,423 | March, 1980 | Al-Kufaishi | 434/178 |
| 4,568,288 | February, 1986 | Patterson | 434/366 |
| 4,650,423 | March 1987, | Sprague, et.al. | 434/156 |
| 5,201,046 | April, 1993 | Goldberg, et.al. | 395/600 |
| 5,261,080 | November, 1993 | Khoyi, et.al. | 395/500 |
| 5,418,948 | May, 1995 | Turtle | 395/606 |
| 5,446,880 | August, 1995 | Balgeman, et.al. | 395/600 |
| 5,499,371 | March, 1996 | Henninger, et.al. | 395/700 |
| 5,604,859 | Feb. 18, 1996 | Ramsay | 365/161; 364/496 |

Design Patents Background

| | | | |
|---|---|---|---|
| D117,149 | October, 1939 | Robin | D20/10 |
| D146,369 | February, 1947 | Millott | D6/470 |
| D266,465 | October, 1962 | Cordony, et.al. | D6/300 |
| D359,988 | July, 1995 | Lechleitter, et.al. | D20/10 |
| D360,230 | July, 1995 | Lechleitter, et.al | D20/10 |

U.S. Pat. No. 4,810,197, “Three-Dimensional instructional device for teaching physical properties and relationships between basic elements”, Mar. 7, 1989. Inventor: Alfonza Hicks. Current U.S. Classification: 434/281; 434/278. International Classification: G09B 23/24; G09B 23/26.

Patent D370,128, “Three Dimensional Periodic Charts Support and Container”, May 28, 1996.; Inventor: Alexander Roy. Current U.S. Classification: D6/300; D6/482; D6/495; D19/77; D19/85.

U.S. Pat. No. 4,831,525, “Method of generating a source program from inputted schematic information”, May 16, 1989. Inventors: Saito, Kazumasa; Maezawa, Hiroyuki; Kobayashi, Masakazu; Futamura, Yoshihiko. Curretn US Classification: 717/3; 707/100; 717/7

U.S. Pat. No. 5,382,166, “Electron-space diagram and display model”, Jan. 17, 1995. Inventor: Ahmose, Rhamal. Current US classification: 434/281; 434/404.

U.S. Pat. No. 4,768,959, “Method of teaching and transcribing of language through the use of a periodic code of language elements”, Sep. 6, 1988. Inventors: Sprague, Robert; Sprague, Joan. Current US Classification: 434/156; 283/46; 283/115; 434/167; 434/185.

U.S. Pat. No. 5,752,021, “Document database management apparatus capable of conversion between retrieval formulae for different schemata”, May 12, 1998. Inventors: Nakatsuyama, Hisashi; Okumura, Yo; Uchida, Go. Current US Classification: 707/5; 707/2; 707/6; 707/100.

U.S. patent application Ser. No. 09/900,670, “The Schemata of the Elements with Scrolling Apparatus”, Jul. 6, 2001, Inventor, Johnson, Charles William, pending application, status in amendment procedure.

### BRIEF SUMMARY OF THE INVENTION

The general approach of the neutronic schemata seeks to visualize the particular patterns of behavior among the elements and their atoms based upon their neutronic periodicity and the concept of nucleonic equilibrium found in the first twenty elements. It is commonly held that the conventional periodic table of the elements is determined solely by the electronic configuration of the elements. The neutronic schemata propose and substantiate the fact that the neutronic count, the neutronic configuration and the nucleonic equilibrium o certain elements, are equally significant in determining certain characteristics and properties of the elements. My invention establiches, and the concept of neutronic periodicity teaches us, that there exists a neutronic periodic table of the elements, which is totally distinct from the electronic and protonic periodic tables.

The conventional periodic table is essentially a protonic table by design, but has attempted to serve as an electronic periodic table with the well-known limited results, given the traditional table's breakdown into different blocks (s, p, d, f blocks). The placement of the Lanthanide and the Actinide Series outside of the main body of the conventional periodic table (or even within it when they are placed inside the “long” table). had made it almost impossible to achieve a visualization of some of the patterns of behavior among the elements and their atoms. My previous invention of the electronic schemata of the elements corrects this aspect of the conventional periodic table, whereby the electronic schema device offers the possibility of creating color-coded, visual patterns of symmetry for the elements and their atoms.

The neutronic periodic table of the elements expressed in the resulting neutronic schema device of the elements, the object of this patent application, now offers the possibility of visualizing the progressive, sequential numerical order of the neutron count within the elements and their atoms and the resulting patterns of symmetry derived thereof. The neutronic schema device is based upon the pattern of nucleonic equilibrium identified within the first twenty representative elements, concerning the number of neutrons in each one of those elements. The neutronic count of the first twenty elements establishes determinant patterns of behavior for the remaining number of elements.

The first twenty elements, based upon their neutronic configuration, determines the baseline of the neutronic schemata which is determined by the number of protons, electrons and neutrons within each element. The baseline of the neutronic schemata is first determined by the first representative twenty elements of the periodic table. The essential patterns within the baseline of the neutronic schemata is then determined by the fact that some elements have the same number of protons, electrons and neutrons in their elemental composition, while other elements have an unequal number of protons, electrons and neutrons in their elemental composition. The fact that all elements have the same number of protons and electrons is generally referred to as electronic neutrality. The nine elements within the first twenty elements, elements 2, 6, 7, 8, 10, 12, 14, 16 20, that have the same correspondingly number of protons, electrons and neutrons is considered in the neutronic periodic table to have a relationship of nucleonic equilibrium between the neutronic and protonic count. The pattern of nucleonic equilibrium of protons and neutrons in an element, the pattern of sameness as it were, substantiates the reason for grouping the elements on the neutronic schemata into different groups from those of the traditional periodic table.

The neutronic schema based upon the placement of rows of twenty elements as of the baseline of the first twenty representative elements and the concept of nucleonic equilibrium, illustrates how the neutronic periodicity of the elements also determines in part the behavior of the elements in terms of their characteristics and properties. A definite neutronic periodic pattern is created according to the twenty groups of elements, as the baseline of the first twenty elements creates subsequent groups of twnety elements that produce a periodic pattern based upon the neutronic configuration of the elements and their corresponding nucleonic equilibrium pattern.

There exists a protonic periodicity based upon the incremental unit of one, beginnig with the Hydrogen atom, whereby the entire periodic table is derived from the progressive aufbau design of the electronic configuration. The essential numbers of protinc periodicity concern the progression of elements expressed in cycles of 2, 8, 8, 18, 18, 32 , 32, and 2 elements per period or cycle. The count is in relation to 120 elements, which constitutes the basic design of the electronic schemata. The electronic periodicity derives a distinct configuration, which is much more complex in nature, and has undergone different interpretations throughout the history of chemistry and physics. The electronic configuration derives a progressive, mirrored sequential ordering of the electrons, according to the shells of 2, 8, 18, 32, 32, 18, 8, and 2 electrons per shell depending upon the elemental case at hand. These numbers of the electronic configuration are also generally in relation to 120 elements.

The neutronic periodicity derives a distinct configuration, which reflects a somewhat more flexible pattern of six periods of 20, 20, 20, 20, 20, 20 for the 120element schema device. Based upon the neutronic schema of the periodic table, we see the existence of horizontal rows of twenty elements per group of elements, on a grid of 6 −20 elemental sectors, with a specific variation within the number of electrons per element (or atom). The progressive number of neutrons for a particular element is not as well defined as those numbers relating to the protonic and electronic counts, but does reflect specific sub-progressions within each neutronic family. The 120-element neutronic schema provides a guideline for extrapolating data with the purpose of predicting the behavior of the elements.

A formula exists for processing and computing the neutron count of some of the elements from elements 21 through 85, as shown:

Neutronic Periodicity

$$\frac{N c ( a ) + N c ( a + 40 )}{2} \approx N c ( a + 20 )$$

Add the neutron count of any two elements on alternating rows on the same column, or on alternating columns of the same row and then divide by 2 and obtain an approximate value for the neutron count of the intermediary row's element on that same column.

$$\frac{N c A + N c C}{2} \approx N c B$$

Where element B is midpoint between elements A and C.

### BRIEF DESCRIPTION OF THE SEVERAL VIEWS OF THE DRAWINGS

Vertical Views

FIG. 1—Neutronic Periodicity, The Electronic Schemata of the Elements, the Neutron Count. This view illustrates the number of neutrons for every element upon the electronic schema. This view of the electronic schema of the elements illustrates the neutron count, that is, the number of neutrons in the atom, for each given element below the atomic number of each element.

FIG. 2.—Neutronic Periodicity, The Electronic Schemata of the Elements, Increments Between Atomic Number (Protons) and Neutrons. This view of the electronic schema of the elements illustrates the neutronic periodicity discovered in relation to the protonic and electronic configuration of the elements on a 120-element electronic schema. The data reflect the increments of neutrons between any given pair of elements, thereby demonstrating the incremental nature of the neutron count among the elements.

FIG. 3—The Neutronic Periodic Table of the Elements, the Basic Neutronic Schema, Neutron Count. This view illustrates the new neutronic periodic table of the elements, the number of neutrons per elemental sector, and its basic neutronic schema, which consists of a grid of six horizontal rows of twenty elemental sectors placed vertically, from one through 120 elements.

FIG. 4—The Neutronic Periodic Table of the Elements, the Basic Neutronic Schema, Electron Terminations. This view illustrates the electronic configuration of the elements in terms of the termination of the number of electrons in each atom for the 120 elemental sectors on the basic neutronic schema, based upon the Bohr Notation numbers.

FIG. 5—The Neutronic Schemata of the Elements, the Twenty Neutronic Groups by Column. This view illustrates the twenty different groups of elements according to the first twenty baseline elements, based upon the nucleonic equilibrium and nucleonic inequality thereof, reading the following families and groups of elements by the twenty columns of elements:

| | |
|---|---|
| 1. | Hydrogen Group |
| 2. | Helium Group |
| 3. | Lithium Group |
| 4. | Beryllium Group |
| 5. | Boron Group |
| 6. | Carbon Group |
| 7. | Nitrogen Group |
| 8. | Oxygen Group |
| 9. | Fluorine Group |
| 10. | Neon Group |
| 11. | Sodium Group |
| 12. | Magnesium Group |
| 13. | Aluminum Group |
| 14. | Silicon Group |
| 15. | Phosphorous Group |
| 16. | Sulfur Group |
| 17. | Chlorine Group |
| 18. | Argon Group |
| 19. | Potassium Group |
| 20. | Calcium Group |

FIG. 6—The Schemata of the Elements, the First Twenty Elements, the Regular Pattern. This view illustrates the alternating pattern of odd-numbered elements and even-numbered elements on the neutronic schema device, according to alternating columns of elements.

FIG. 7—The Schemata of the Elements, the First Twenty Elements, the Regular Pattern. This view illustrates the pattern of shells on the neutronic schema device.

FIG. 8—Neutronic Periodicity. This view illustrates the direction of the pattern of neutronic periodicity, which is read in a downward direction, by columns, for the 120-element neutronic schema device, where proportional spacing of the neutronic periodicity proceeds by rows of twenty elements.

FIG. 9.—The Schemata of the Elements, Metals, Metalloids and Non-Metals. This view illustrates the metals, metalloids and non-metals as registered on the 120-element neutronic schema device.

FIG. 10—Acidity on the Neutronic Schema. This view illustrates the pattern of those elements reflective of the characteristic and property of acidity on the 120-element schema device.

FIG. 11—Basicity on the Neutronic Schema. This view illustrates the pattern of those elements reflective of the characteristic and property of basicity on the 120-element schema device.

FIG. 12—The Schemata of the Elements, the Pattern of Sameness, the First Twenty Elements. This illustration illustrates the pattern of nucleonic equilibrium for the first twenty elements of the periodic table of the elements, where elements 2, 6, 7, 8, 10, 12, 14, 16 and 20 have the same corresponding number of protons, electrons and neutrons in their atomic composition.

FIG. 13—The Neutronic Schema, Breakdown of Symmetry of the Baseline. This illustration shows the breakdown in the symmetry of the first twenty elements with an equal number of protons, electrons and neutrons in their composition; as well as, those elements numbers 1, 3, 4, 5, 9, 11, 13, 15, 17, 18, and 19 that have an unequal number of protons, electrons and neutrons in their composition.

FIG. 14—Nucleonic Equilibrium, The Neutronic Schema, Breakdown of Symmetry of the Baseline. This illustration shows the internal relationship of the first twenty elements in terms of their pattern of symmetry, both theoretically and hypothetically.

FIG. 15—The Neutronic Periodic Table of the Elements, Projected Cycles and End Tables for 168 and 218 Elements. This view illustrates the neutronic periodic table with a projected schema for elements 1 through 166-168 and 1 through 216-218 elements

FIG. 16—The Neutronic Periodic Table of the Elements, Projected Cycles and End Tables for 168, 218 and 504 Elements. This view illustrates the neutronic periodic table with a projected schema for elements 1 through 166-168, 1 through 216-218, and 1 through 504 elements.

FIG. 17—The Neutronic Families, Neutronic Groups of Elements, Neutron Number Divided by the Atomic Number of Each Element. This view illustrates the numbers relatd to the neutron count when each number of corresponding neutrons to each element is divided by the corresponding number of protons for each element.

FIG. 18—The Schemata of the Elements, Coherent Scattering Length. This view illustrates how a near perfect pattern of dominant translation symmetry for alternating rows of two elemental sectors with a downward decremental tendency.

FIG. 19—The Neutronic Schemata of the Elements, 220 Elements. This view illustrates the neutronic schema for 220 elements.

FIG. 20—The Neutronic Schemata of the Elements, Pattern of Baseline First Twenty Elements Through 220 Elements, Transition Elements Commencement. This view illustrates the appearance of the transition elements in their commencement cycle upon the 220-element neutronic schema and their relationship to the patterns contained in the first twenty elements of nucleonic equilibrium or nucleonic imbalance.

Horizontal Views

FIG. 21—The Schemata of the Elements, Bond Strengths in Diatomic Molecules, Oxygen (0-)//Kcal moles⁻¹. This view illustrates sub-patterns of centrosymmetry within the first twenty elements.

FIG. 22—The Schemata of the Elements, Bond Lengths of Elements. This view illustrates the incremental tendency of values on the left side of the neutronic schema and the decremental tendency of values on the right side of the neutronic schema.

FIG. 23—The Neutronic Periodic Table of the Elements, Neutron Resonance Integral, An Example in Centrosymmetry. This view illustrates how the numerical data are related to sub-patterns of centrosymmetry on the neutronic schemata device, where series of numbers for groups of elements appear to emanate from a perceived center.

FIG. 24—Traditional Classification of Major Groups of Elements on the Neutronic Schemata of the Elements. Symmetries of Hydrogen and the Alkali Metals, X-Ray Emission Spectra Data in Angstroms. This view illustrations the decremental tendency of the numerical data for x-ray emission spectra on the neutronic schema device for Hydrogen and the Alkali Metals.

FIG. 25—Traditional Classification of Major Groups of Elements on the Neutronic Schemata of the Elements. The Transition Metals, X-Ray Emission Spectra Data in Angstroms This view illustrates the relationship of the transition metals with the baseline pattern of anomalies for the first twenty elements.

FIG. 26—Metallic Radii for C.N. 12. This view illustrates alternating groups of elemental sectors with decremental or incremental tendencies on the neutronic schema device.

FIG. 27—The Neutronic Schema of the Elements: Elements 21 Through 61, Given and (Projected) Average Neutron Count Between Two Elements on the Same Column. This view illustrates how the neutron count of an element is approximate to half the value of the sum of the neutron counts of the two elements adjacent to that element on the same column. Whereby, for example, the sum of the neutron counts of element 36 and element 76, given as 48 and 114 neutrons respectively, 162 total when divided by 2, yields the number 81 neutrons, which is the given neutron count of element 56 that lies between elements 36 and 76 on the same column on the neutronic schema device.

FIG. 28—The Neutronic Schema of the Elements: Elements 61 Through 92, Given and (Projected) Average Neutron Count Between Two Elements on the Same Column.

### DESCRIPTION OF THE INVENTION

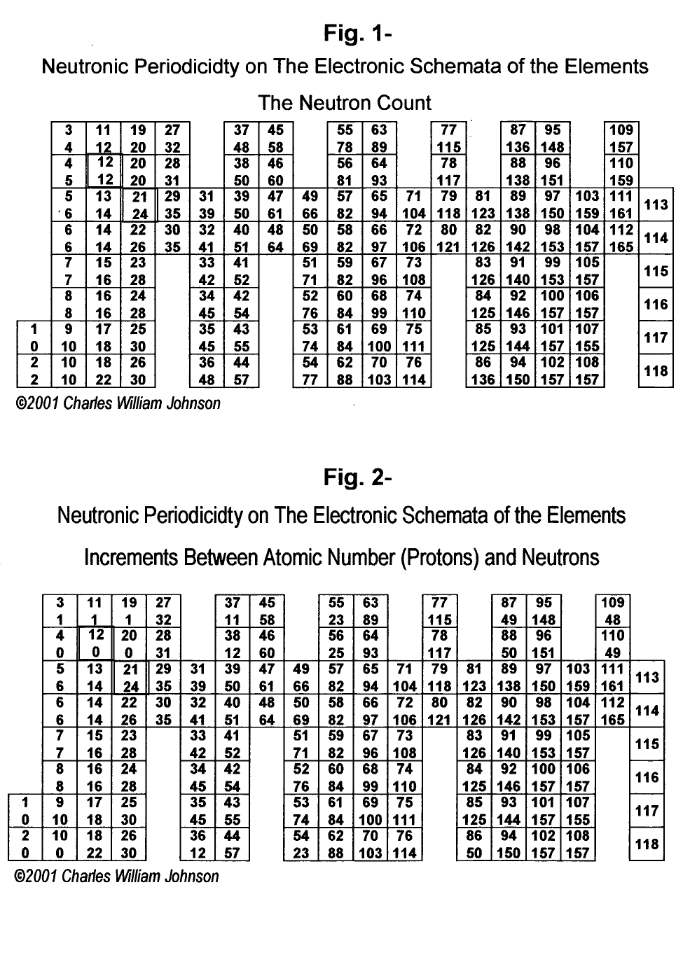

It is generally held that the electron configuration, through adding an additional electron to each successive atom, determines the characteristics and properties of the elements and their atoms. For this reason, the electronic configuration of the elements is said to determine the composition of the periodic table of the elements itself The progressive addition of one proton and one electron to each atom does not determine the charactristics and properties of the elements alone. We base our invention of the neutronic periodic table of the elements on the fact that neutrons are being subtracted and added to the elements and their atoms (FIG. 1 and FIG. 2), whereby the neutronic configuration, nucleonic equilibrium and, neutronic periodicity also determine the characeristics and properties of the elements and their atoms.

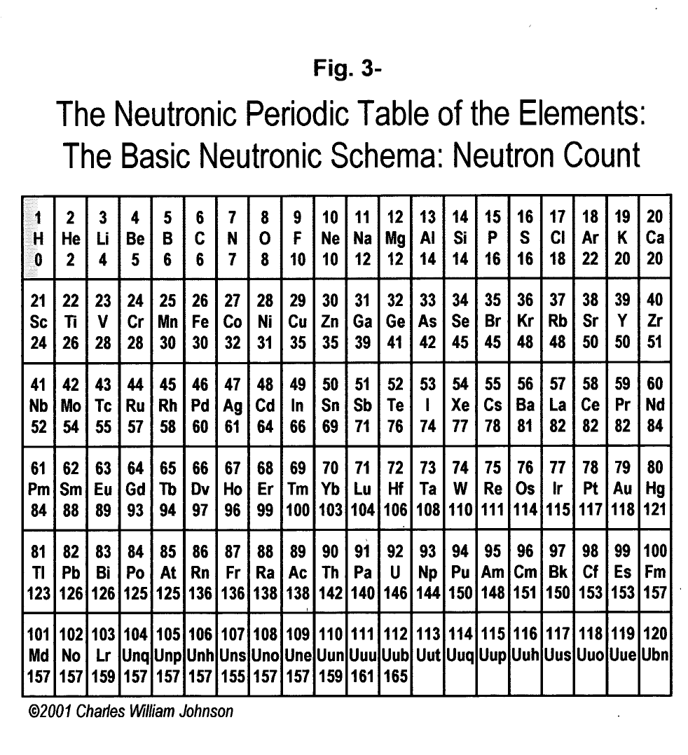

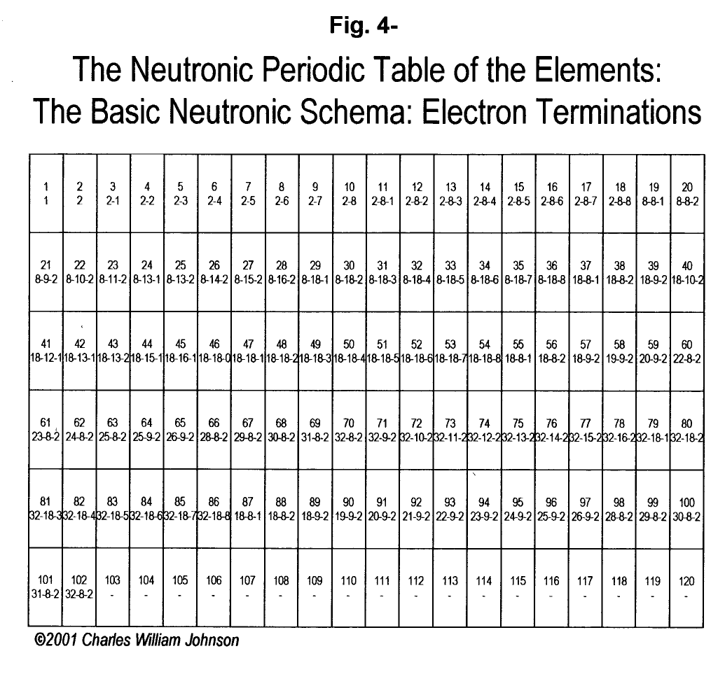

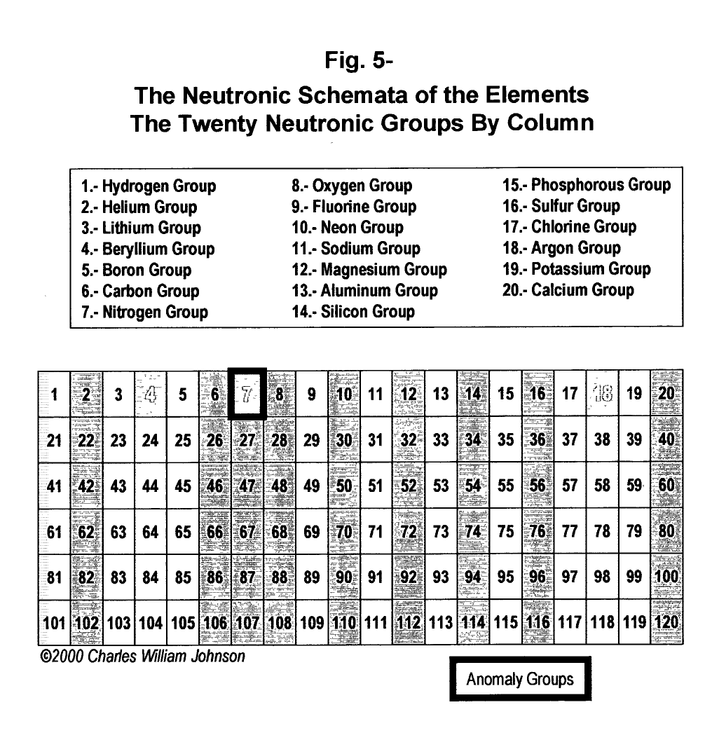

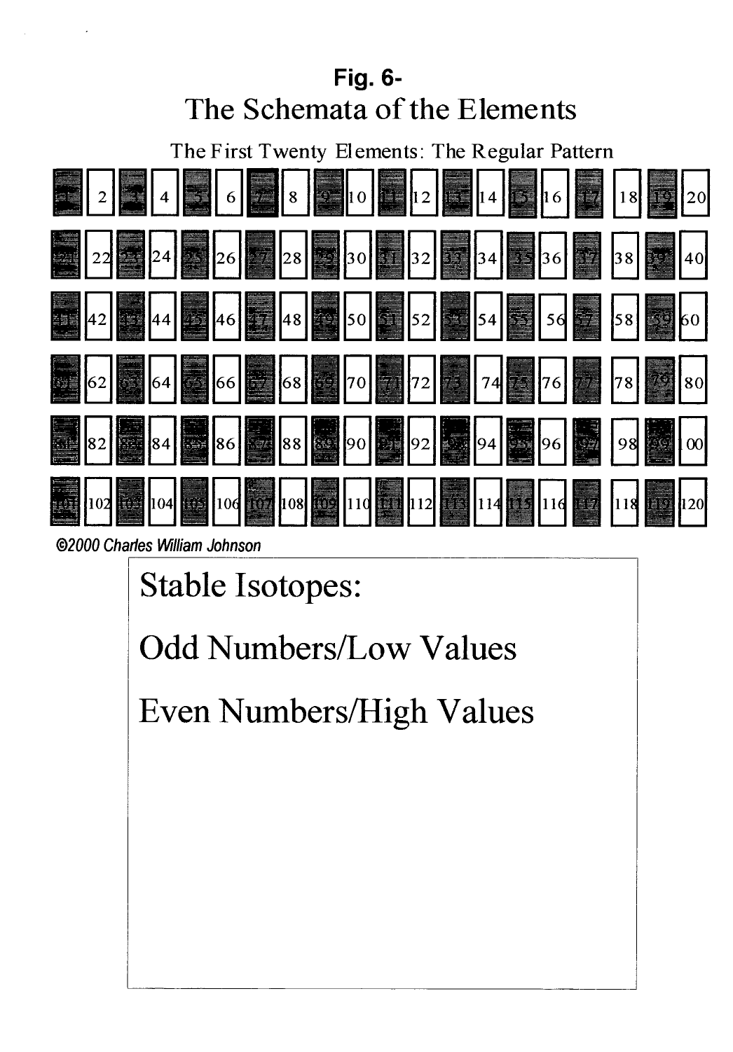

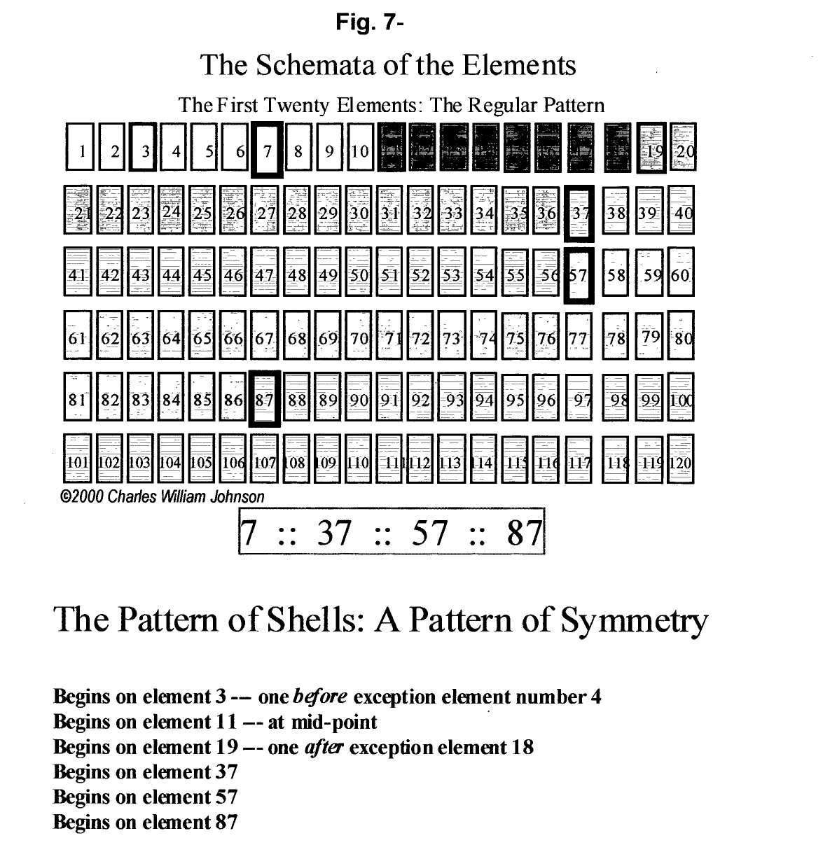

The combined interaction of the proton, the electron and the neutron determines the characteristics and properties of the elements. It is the combination and interaction of the distinct protonic, electronic and neutronic counts and configurations that determine in and of themselves the characteristics and properties of the elements and their atoms. Therefore, the commonly held idea that the electronic configuration alone determines the characteristics and properties of the elements is placed aside, since all of the constituent levels of the atom, the protonic, neutronic and electronic levels, serve as the basis for understanding the neutronic periodic table and its schemata (FIG. 3).

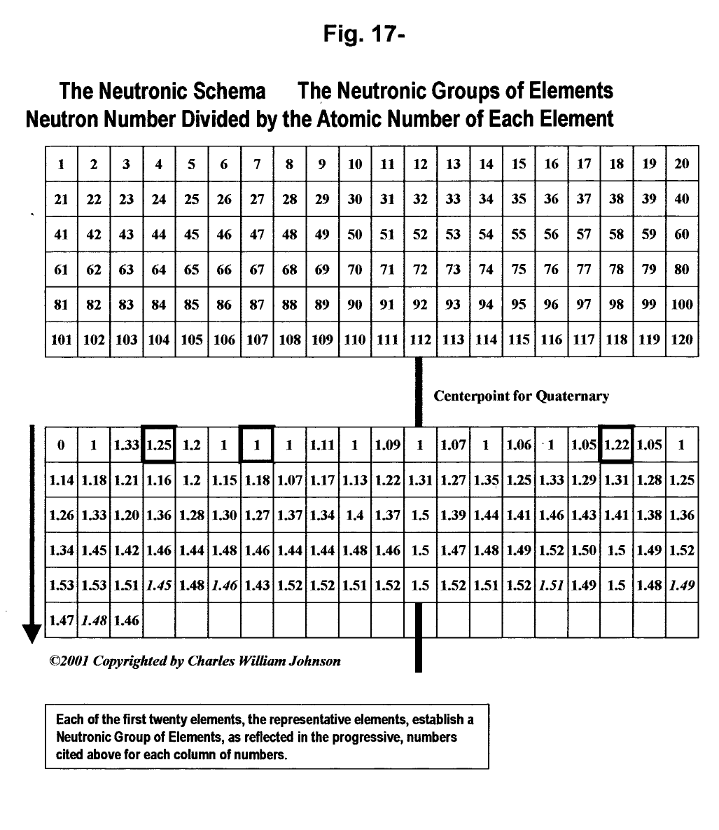

There exist protonic, electronic, and neutronic schemata of the elements in relation to my invention of the neutronic periodic table of the elements. The protonic aspect of the elements reflects its own periodicity regarding the progressive incremental nature of the singular addition of a Hydrogen proton to each distinct element on the periodic table. The distinctive electronic periodicity of the configuration of the electrons in an atom exists beyond any doubt, as is illustrated in the traditional periodic table of the elements. My invention establishes the recognition of a neutronic periodicity, which is less predictive and systematic in nature than the protonic and electronic periodicities, but equally determinant of some of the characteristics and properties of the elements (FIG. 17).

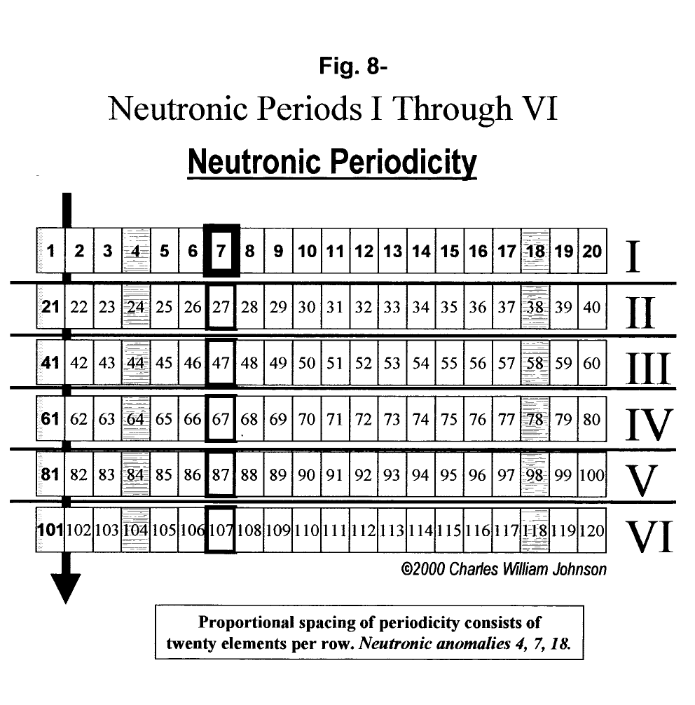

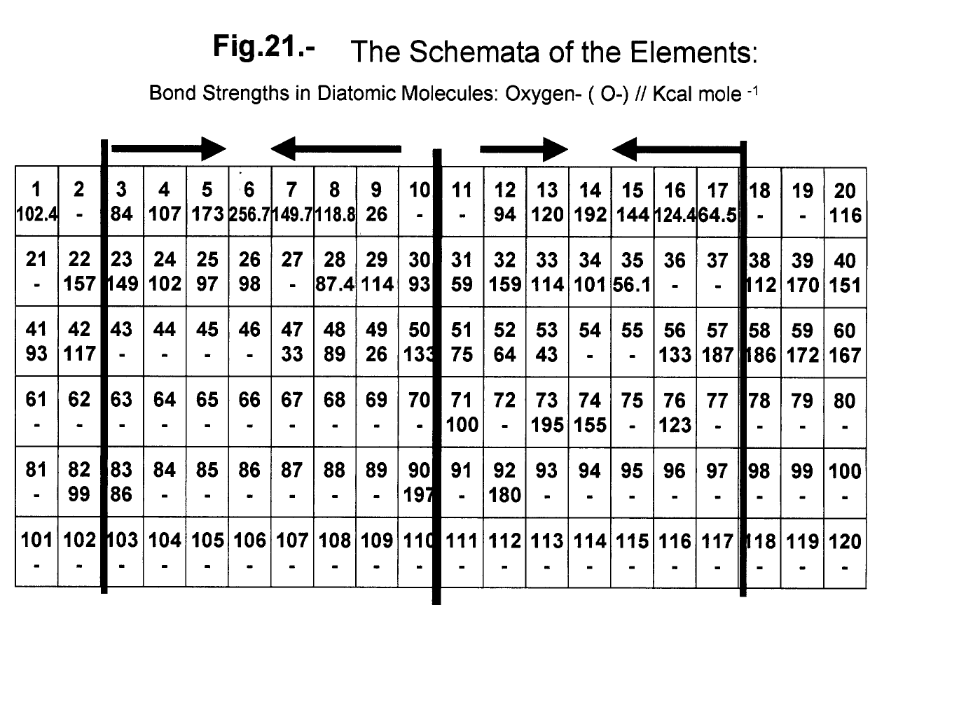

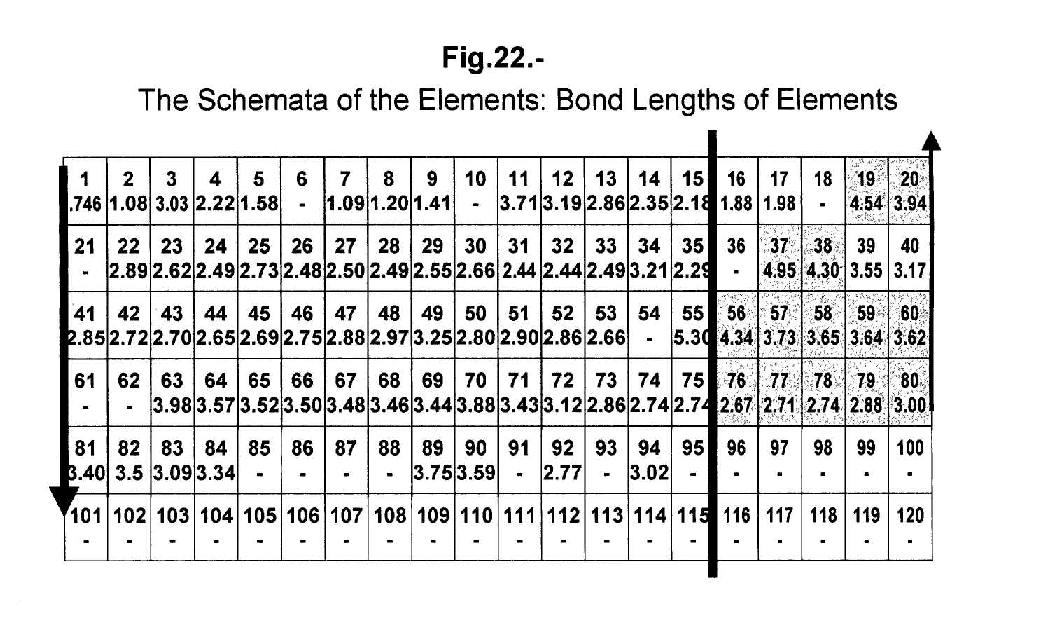

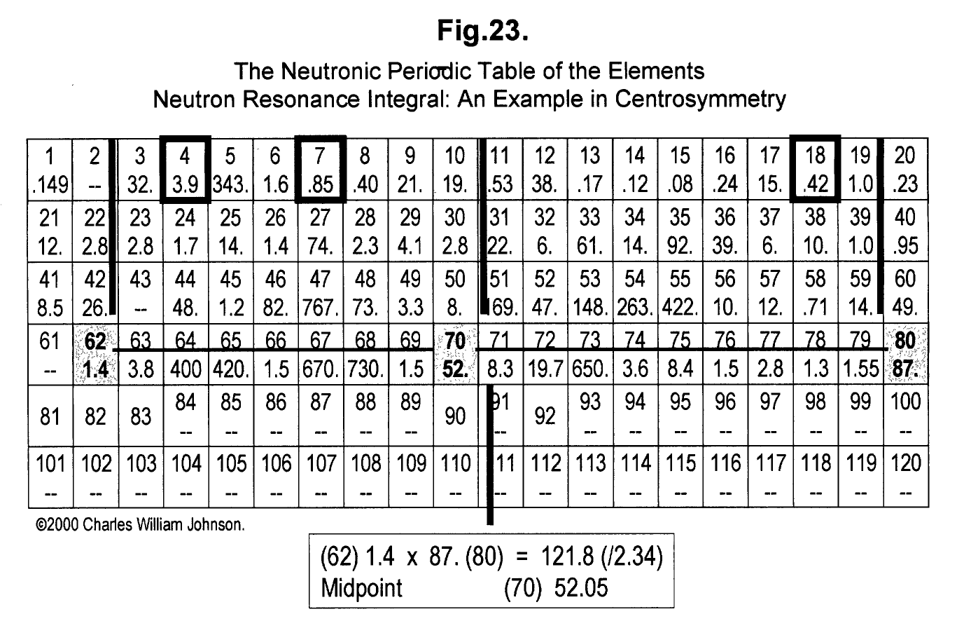

The neutronic periodic table and its corresponding schemata illustrate the fact that the neutronic periodicity determines specific aspects of the elements and their atoms, which generally have gone unrecognized to date (FIGS. 21-23, FIG. 25, and FIGS. 27-28). The lack of recognition of neutronic periodicity (FIG. 8) comes from the simple fact that the very concept itself of neutronic periodicity has not been consciously formulated in the physical and chemical literature to date. The protonic periodicity is also generally ignored or taken for granted. Whereas emphasis has generally been given to the electron, and its electronic configuration, whereby the concept of electronic configuration is generally held to be the single factor in determining the characteristics and properties of the elements. The approximate value of neutronic periodicity may be expressed in a basic formula concerning neutronic elemental triad arrays of the elemental sectors in the terms as follows.

Nc(20)+Nc(60)/2≈Nc(40)

$$\frac{N c ( a ) + N c ( a + 40 )}{2} \approx N c ( a + 20 )$$

Where Nc equals the neutron count, the number of neutrons in a selected element (a), where a is the atomic number of the selected element. Select any two elements on alternating rows of the same column, add together the respective number of neutrons in each of the two selected elements, then, divide the sum of those two neutron counts by 2, in order to obtain an approximate value for the neutron count for the element lying on the intermediary row on that same column between the two selected elements.

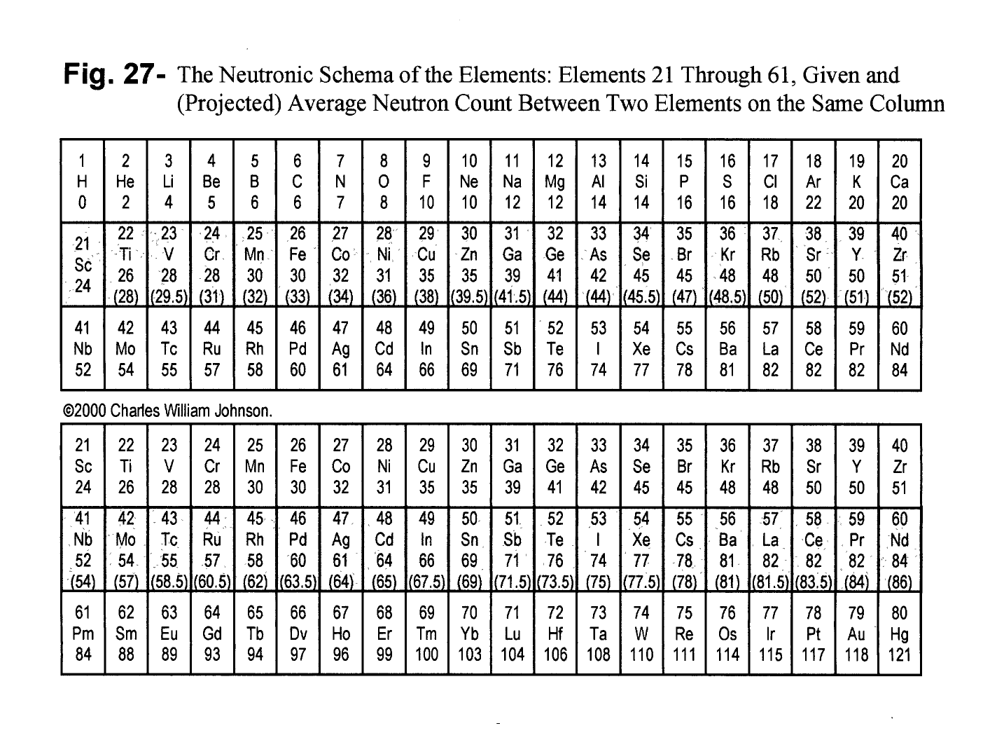

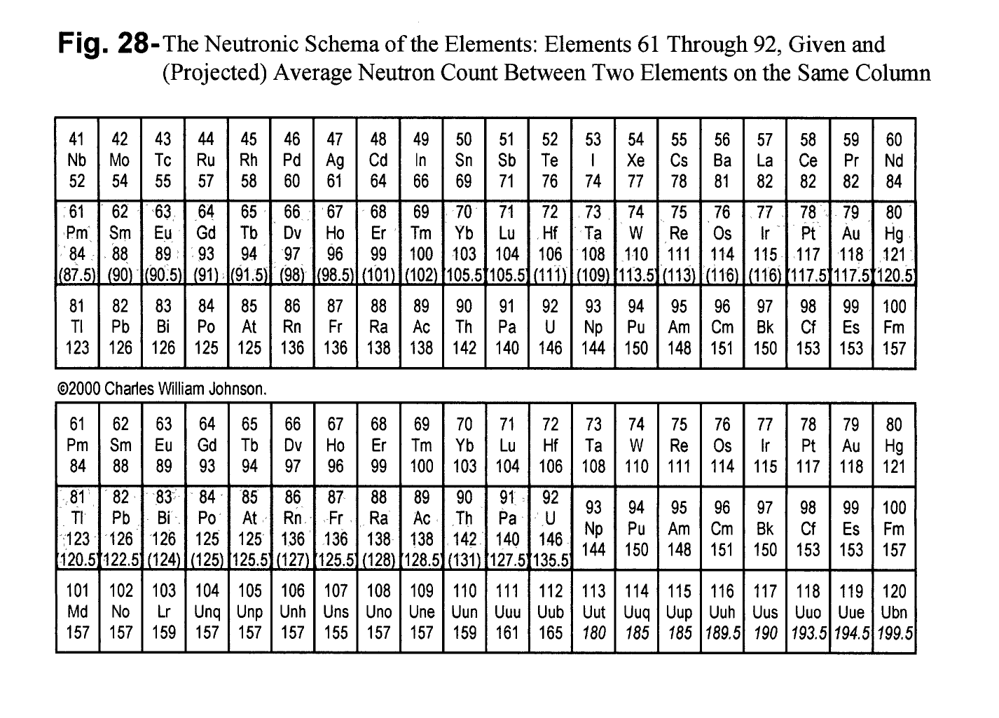

The neutronic elemental triads show that the neutron count of an element is approximate to half the value of the sum of the neutron counts of the two elements adjacent to that element on the same column (FIGS. 27-28), whereby, using as an example, the sum of the neutron counts of element 36 and element 76 are given as 48 and 114 neutrons respectively, giving a total of 162 neutrons, when divided by 2 yields the number of 81 neutrons, which is the given neutron count of element 56 that lies between elements 36 and 76 on the same column on the neutronic schema device. For the neutronic triad array of elements 36-56-76, element 36 has 48 neutrons, element 56 has 81 neutrons and, element 76 has 114 neutrons, whereby in terms of the formula for determining an approximate value for the neutronic count of an element within any of the valid neutronic triad arrays, the following obtains:

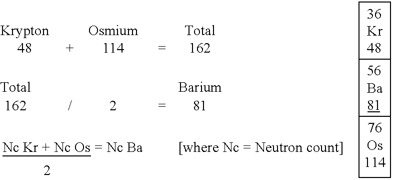

For the neutronic triad array of elements numbered 66-86-106 through the triad array of elements numbered 80-100-120, this particular formula ceases to yield an approximate relation of equivalency in the terms of the cited formula, whereby the differences between the actual neutron count and the product of the division formula are much larger than in the triad arrays from elements 2-22-42 through triad array elements 65-85-105. In summary, the use of this formula is helpful in comprehending the approximate relationship of the neutron count and the neutronic periodicity for elements 22 through 85, given the fact that elements 22 through 40, 41 through 60, 61 through 80, and 81 through 85, are listed one intermediate rows on the neutronic schema device, whereas elements 1 through 20 do not form an intermediate row for the application of the formula (FIGS. 27-28).

The neutronic schema device is distinct from that of the electronic schema device, both theoretically and practically. The electronic schema is based upon the electronic configuration, and an 8×20 grid. While the neutronic schema, described herein, is based upon the neutronic configuration and nucleonic equilibrium, and is represented by a schema device based on a basic 6×20 grid. The neutronic periodic table processes and produces physical and chemical data, quantitatively and qualitatively distinct from the electronic schemata of the elements (FIGS. 27-28). The distinction may be observed in the corresponding patterns of symmetry portrayed by the neutronic configuration and neutronic periodicity, which differs greatly from the electronic schema device (FIG. 2 and FIG. 3.).

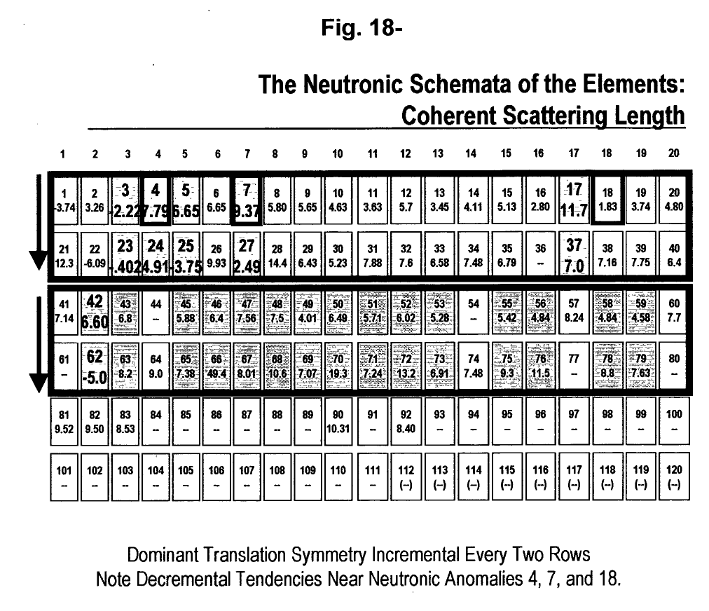

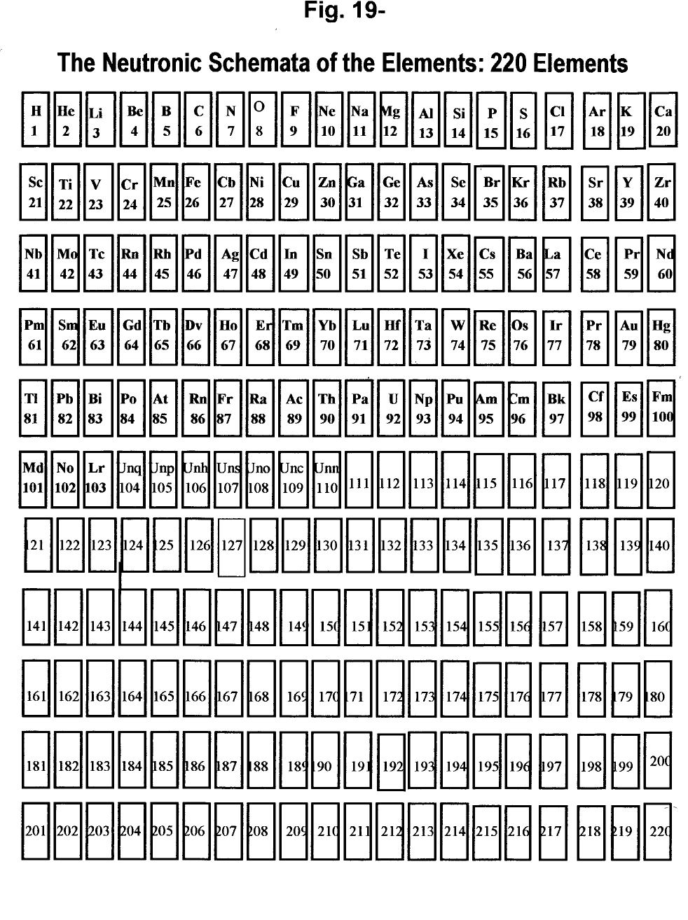

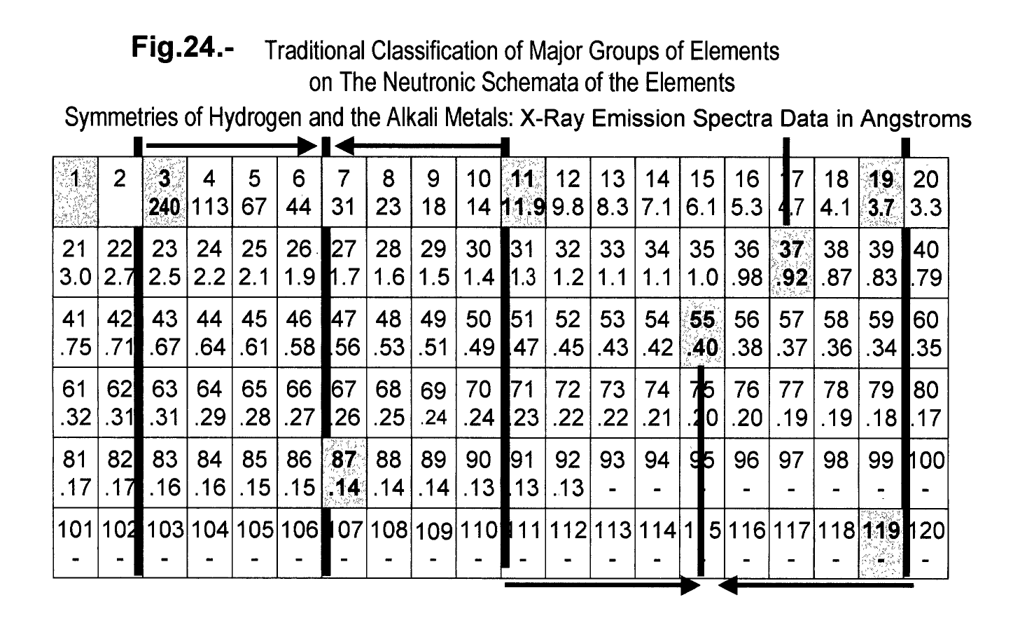

In the past, the neutronic configuration has been taken for granted even much more than the protonic configuration, due mainly to its being less predictive in terms of incremental and decremental quantities in the neutron count for each atom (FIG. 1 and FIG. 3), other its treatment in the table of nuclides. Nevertheless, our invention proves that the neutron and its configuration and periodicity are determinant of some of the characteristics and properties of the elements and their atoms similarly as are the proton and the electron (FIG. 18.). In order to visualize the neutronic configuration and neutronic periodicity of the elements and their atoms, as of the number of neutrons associated with each particular element, in my invention I employ the first twenty elements as the baseline of the neutronic periodic table and its associated schemata. Generally, the first twenty elements are cited as being the “representative” or “regular” elements, which present patterns that are more discernible and predictive than the patterns portrayed by the commonly known transition elements (FIG. 24).

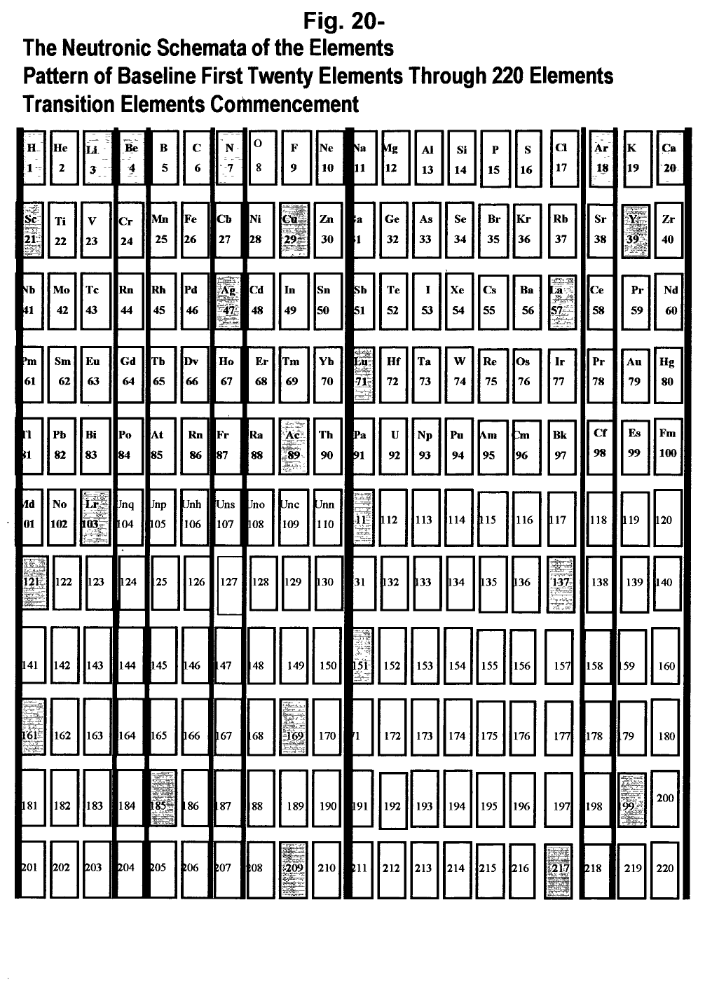

In the neutronic periodic table of the elements, we are accounting for those aspects of the elements and their atoms derived from the behavior of the neutron in relation to that of the proton and electron. The neutronic periodic table and its schemata are complementary with the electronic and protonic tables of the elements. The proton, the electron and the neutron exist as a singular relationship within the elements and their atoms. The neutronic periodic table emphasizes the neutron configuration and periodicity that have been generally overlooked on the conventional periodic table (FIG. 20).

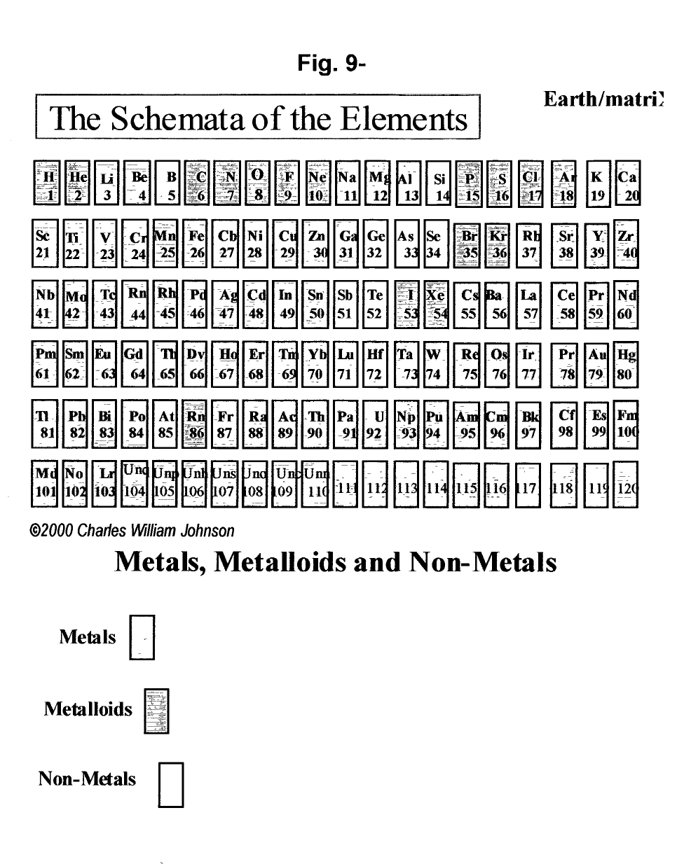

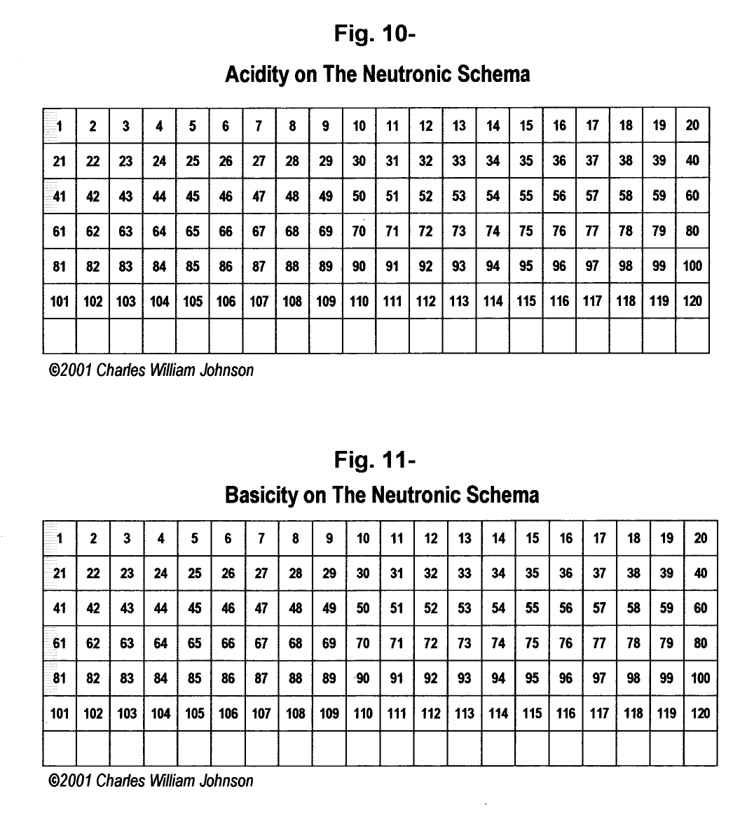

In this manner, the neutronic schemata must be viewed as being complementary to and as an improvement upon the conventional protonic-electronic periodic tables (FIG. 9). As we have illustrated herein with the neutronic schemata of the elements, there is a progressive periodicity of the neutron count as well, but the neutronic periodicity has been downplayed upon the periodic table. The periodic table was originally defined as of atomic weight, then atomic number, with the aspect of electronic configuration being generally recognized as the defining feature of the conventional periodic table. This obtains as of the regular or irregular pattern of the electronic count based on the orbital conception of the transfer of energy within the atom.

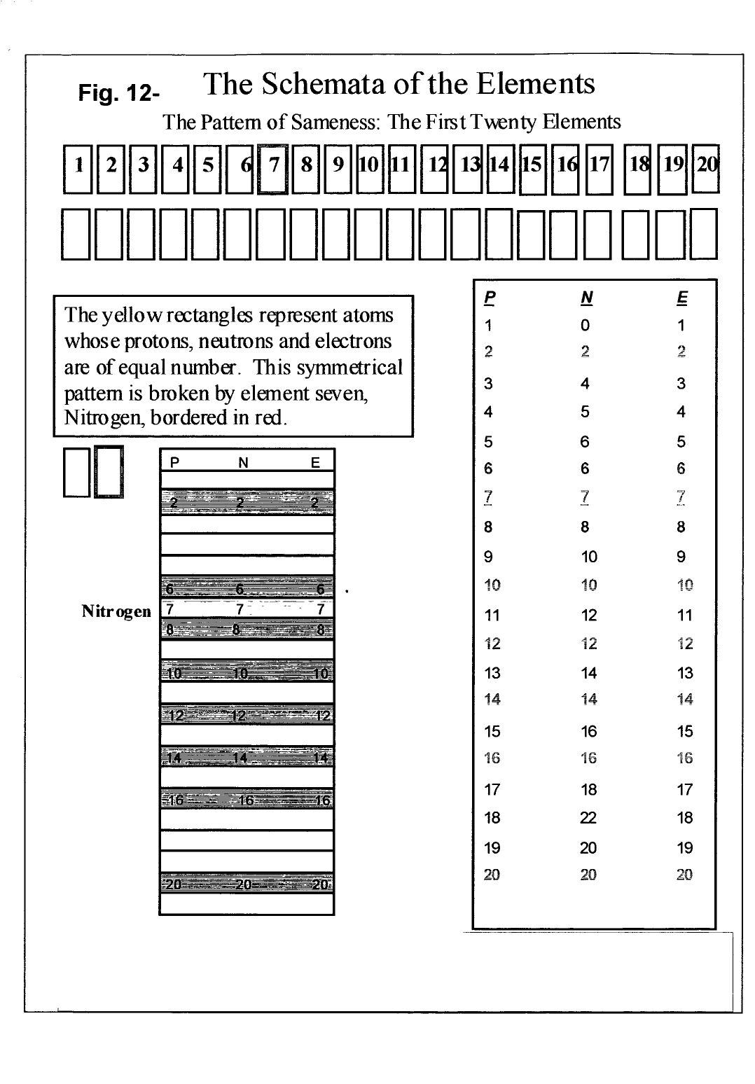

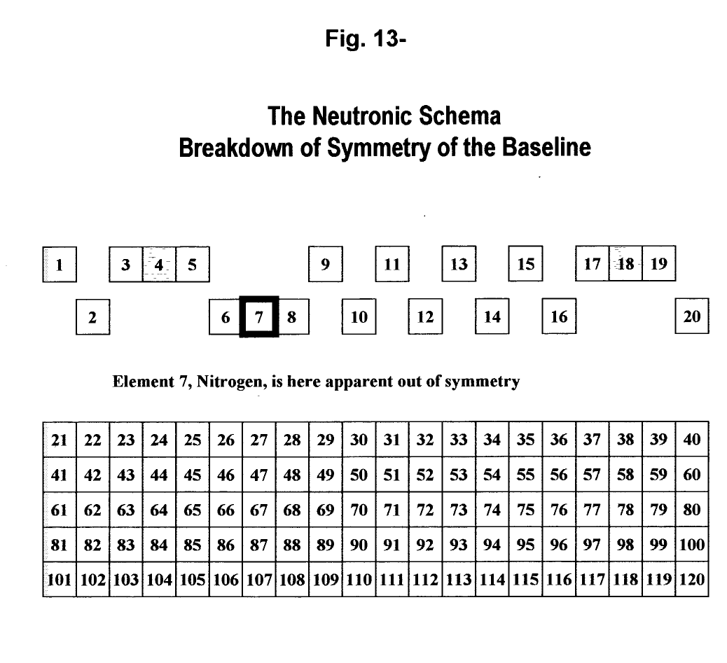

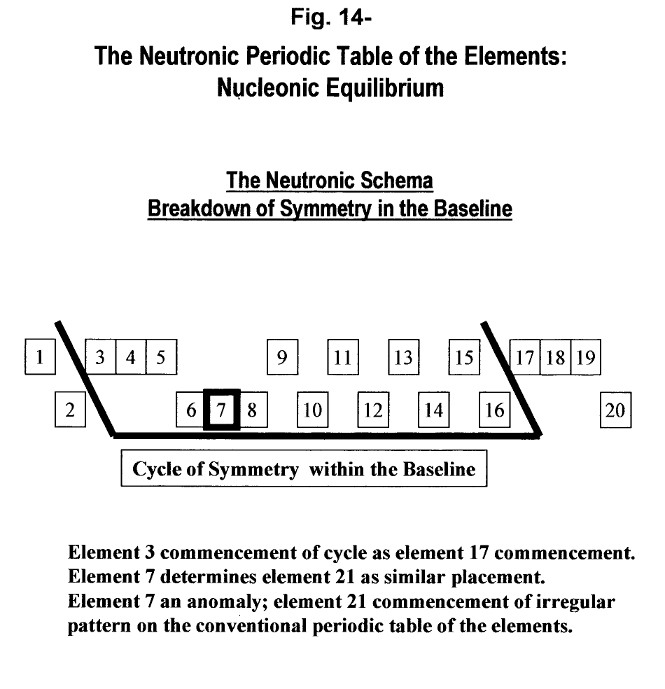

With the neutronic periodic table and its neutronic schemata of the elements, the patterns of symmetry determined by the neutronic count (FIGS. 13-14) may be processed and display on the schema device, which is the object of my invention. The neutronic schemata allow us to process and display patterns of symmetry as of the neutronic configuration, nucleonic equilibrium and neutronic periodicity, which complement and improve the explanations of the characteristics and properties of the elements that the protonic and electronic periodic tables are unable to illustrate or display. It is from this theoretical perspective that I have invented the neutronic periodic table and its schemata using the baseline of the first twenty representative elements in terms of their neutronic count, neutronic periodicity and nucleonic equilibrium (FIG. 12).

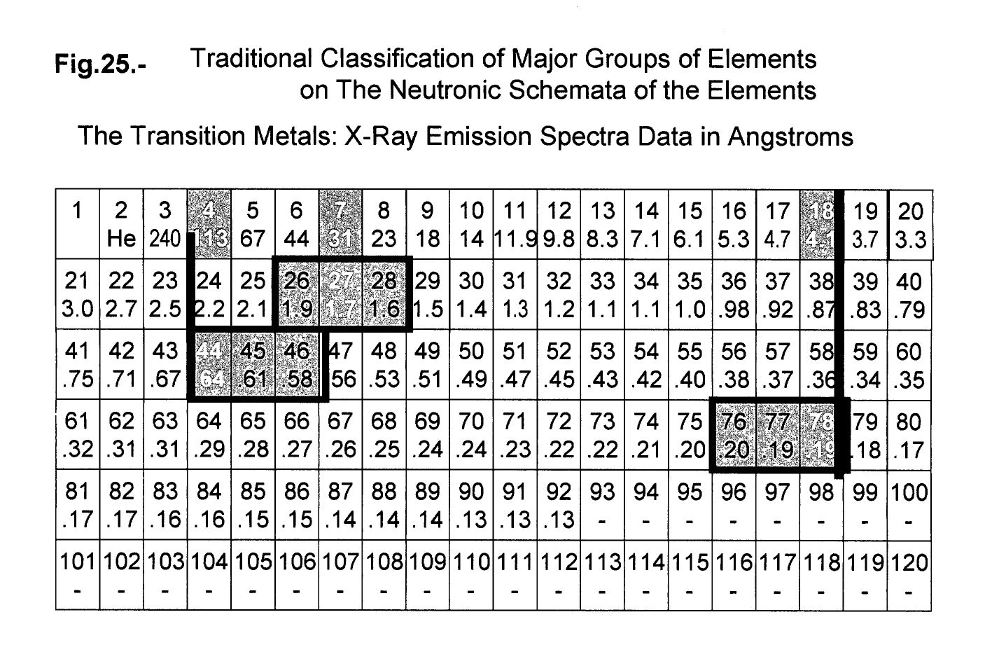

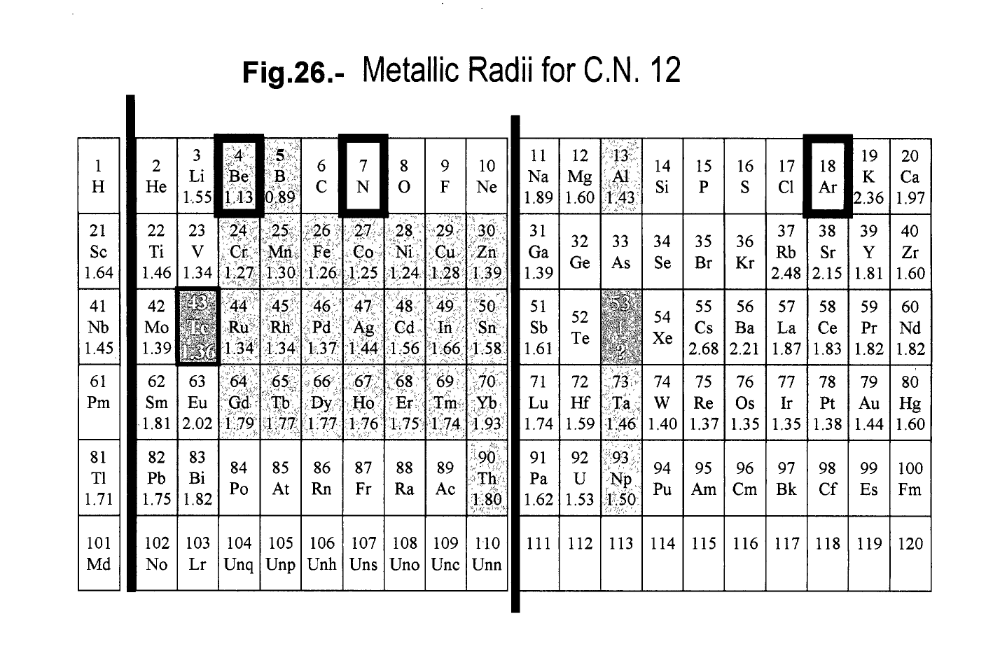

New and original aspects and features of specific elements become more comprehensible in the light of the patterns based on neutronic configuration and periodicity, than those based solely on the protonic and electronic counts (FIGS. 25-26). The neutronic patterns of symmetry obey the periodicity of the neutron count, rather than solely the protonic or electronic periodicities. There are distinctive neutronic schemata for the different neutronic aspects and features of the elements. In other words, there is a distinctive neutronic schema for each particular relationship of the elements and their atoms based upon neutronic configuration and periodicity. In this sense, the neutronic periodic table of the elements and its neutronic schemata are infinite and limitless, just as the relationships among the elements themselves and their atoms are without recognized boundaries (FIGS. 21-26).

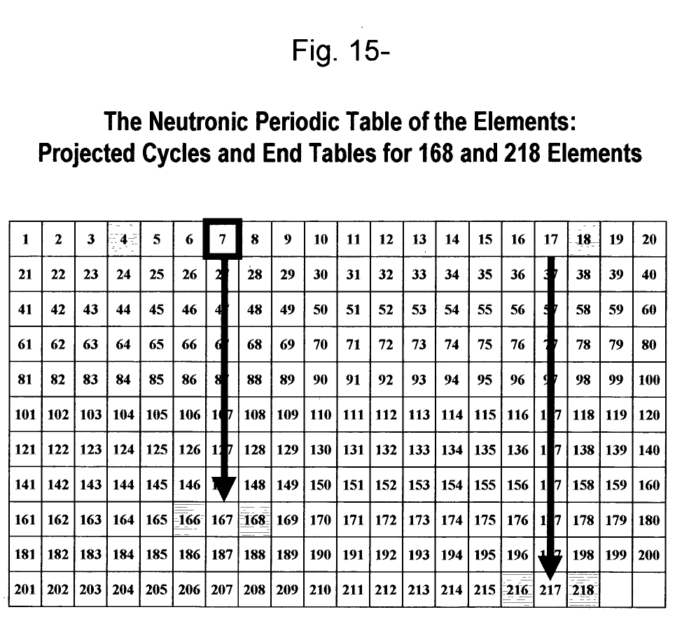

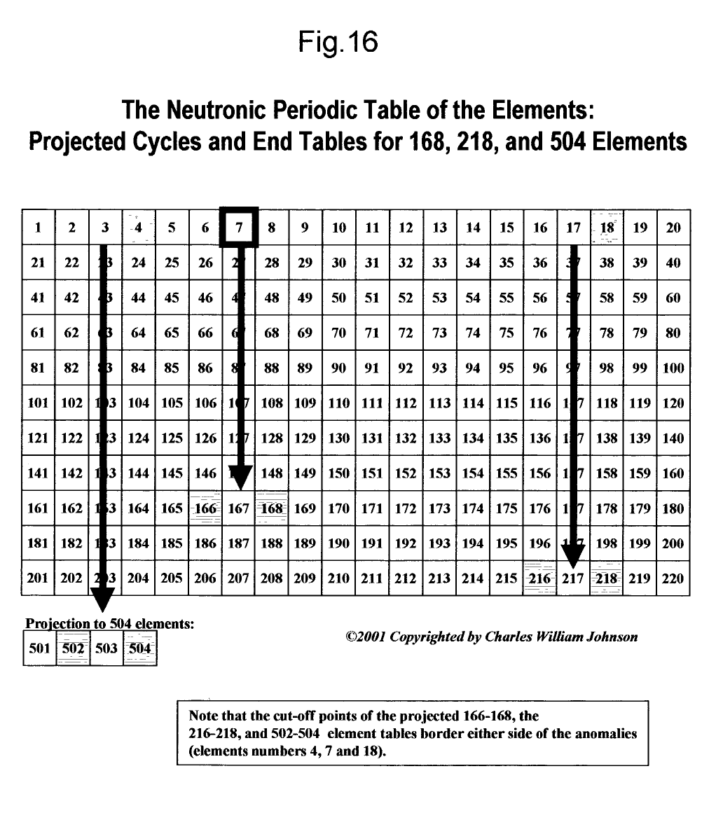

The basic neutronic periodic table of the elements and its schemata consist of six rows of twenty columns of elemental sectors, as described and illustrated in the drawings that accompany this patent application. The basic 6×20 grid of elemental sectors on the neutronic schema device consists of projected neutronic periodic tables of 1 through 168 elements and elements 1 through 218 elements (FIG. 15), with a hypothetical projection of 1 through 504 elements (FIG. 16). The 120-element neutronic schema consists of 120 elemental sectors that read from left to right, commencing with Hydrogen element 1, in a progressive numerical order: element 1 through 20 on the first row; elements 21 through 40 on the second row; elements 41 through 60 on the third row; elements 61 through 80 on the fourth row; elements 81 through 100 on the fifth row; and elements 101 through 120 on the sixth row (FIG. 3). The neutronic periodicity of the elements (FIG. 1 and FIG. 2) is established as of the number of neutrons in the atom of each element.

I claim as my invention A Neutronic Periodic Table of the Elements with Neutronic Schema Device, based upon the following claims:

1.- A neutronic periodic table of the elements with a schema device based upon the neutronic periodicity of the elements and their nucleonic equilibrium or inequality, which comprises a grid of 1 through eleven rows of elemental sectors by 1 through twenty columns of elemental sectors, whose elemental sectors placed from let to right in a progressive numeration by rows, where said elemental sectors may contain quantitative and qualitative indicia for physically and visually processing and displaying physical and chemical data on the schema device, according to the elements and their atoms, containing elements 1 through 20 in row one; elements 21 through 40 in row two; elements 41 through 60 in row three; elements 61 through 80 in row four; elements 81 through 100 in row five; elements 101 through 120 in row six; elements 121 through 140 on row seven; elements 141 through 160 in row eight; elements 161 through 180 in row nine; elements 181 through 200 in row ten; and elements 201 through 220 in row eleven; with a plurality of elemental sectors being projected as required upon the desired expanded grid

2.- The physical and visual arrangement of the baseline apparatus that contains the first twenty representative elements on the first row of elements 1 through 20, determined thereupon by the division of elements 2, 6, 7, 8, 10, 12, 14, 16, 20 as being representative of the nucleonic equilibrium, or the pattern of sameness, whereupon each one of said elements contains an equal number of protons and neutrons in their respective nucleus, and further determined therein by the division of odd-numbered elements 1, 3, 4, 5, 9, 11, 13, 15, 17, 18, 19 as representative of nucleonic inequality, whereupon said elements contain an unequal number of protons and neutrons in their respective nucleus, referencing the first twenty representative elements of the neutronic periodic table and its neutronic schema device.

3.- The apparatus of claim 1 further comprises the movement of the elemental sectors either vertically or horizontally, by individual elemental sectors, by rows of elemental sectors, or by columns of elemental sectors, or by arrays and groups of elemental sectors, rendering the physical and visual processing and displaying of quantitative and qualitative indicia referencing physical, and chemical data on each elemental sector, resulting in the arrangement of patterns of symmetry and asymmetry, by incremental or decremental tendencies, in relation to the neutronic periodicity and nucleonic equilibrium of the baseline for the groups of elements defined by the neutronic schema of the elements, whereby the classification of the groups of elements on the neutronic schema is defined as the Hydrogen group with elements 1, 21, 41, 61, 81, 101, 121, 141, 181, 201; the Helium group with elements 2, 22, 42, 62, 82, 102, 122, 142, 162, 182, 202; the Lithium group with elements 3, 23, 43, 64, 83, 103, 123, 143, 163, 183, 203; the Beryllium group with elements 4, 24, 44, 64, 84, 104, 124, 144, 164, 184, 204; the Boron group with elements 5, 25, 45, 65, 85, 105, 125, 145, 165, 185, 205; the Carbon group with elements 6, 26, 46, 66, 86, 106, 126, 146, 166, 186, 206; the Nitrogen group with elements 7, 27, 47, 67, 87, 107, 127, 147, 167, 187, 207; the Oxygen group with elements 8, 28, 48, 68, 88, 108, 128, 148, 168, 188, 208; the Fluorine group with elements 9, 29, 49, 69, 89, 109, 129, 149, 169, 189, 209; the Neon group with elements 10, 30, 50, 70, 90, 110, 130, 150, 170, 190, 210; the Sodium group with elements 11, 31, 51, 71, 91, 111, 131, 151, 171, 191; the Magnesium group with elements 12, 32, 52, 72, 92, 112, 132, 152, 172, 192, 212; the Aluminum group with elements 13, 33, 53, 73, 93, 113, 133, 153, 173, 193; the Silicon group with elements 14, 34, 54, 74, 94, 114, 134, 154, 174, 194; the Phosphorous group with elements 15, 35, 55, 75, 95, 115, 135, 155, 175, 195; the Sulfur group with elements 16, 36, 56, 76, 96, 116, 136, 156, 176, 196; the Chlorine group with elements 17, 37, 57, 77, 97, 117, 137, 157, 177, 197; the Argon group with elements 18, 38, 58, 78, 98, 118, 138, 158, 178, 198; the Potassium group with elements 19, 39, 59, 79, 99, 119, 139, 159, 179, 199; and, the Calcium group with elements 20, 40, 60, 80, 100, 120, 140, 160, 180, 200, 220; which make up the neutronic periodic table of the elements and its corresponding groups of elements.

4.- The apparatus of claim 1 further comprises the proportional spacing of the neutronic periodicity of the elements defined on the neutronic periodic table and its schemata whereby the neutronic periodicity is physically and visually displayed on the horizontal axis in increments of one from one elemental sector to the following elemental sector, reaching twenty elemental sectors per row, and on the vertical axis of the neutronic periodic table and its schemata, whereby the periodicity is physically and visually displayed in increments of twenty elements from one elemental sector to the one below or above it on the columns, thus establishing a specific concept of neutronic periodicity wherein period one consists of elements 1 through 20; period two consists of elements 21 through 40; period three consists of elements 41 through 60; period four consists of elements 61 through 80; period five consists of elements 81 through 100, period six consists of elements 101 through 120; and theoretically period seven consists of elements 121 through 140; theoretically period eight consists of elements 141 through 160; theoretically period nine consists of elements 161 through 180; theoretically period ten consists of elements 181 through 200; theoretically period eleven consists of elements 201 through 220; and subsequently thereafter every twenty elements in this manner defines a theoretically posited new period, which is reflected in the symmetry of quantitative and qualitative data that show incremental and decremental tendencies by rows and by columns with few exceptions or minimal exceptions to the sequential progression of numerical data reflective of the characteristics and properties of the elements.

5. The apparatus of claim 1 further comprises the schema device for physically and visually processing and displaying the arrangement of the anomaly elements 4, 7 and 18 of the baseline of the first twenty elements, inasmuch as the even-numbered elements 4 and 18 contradict the pattern of nucleonic equilibrium by having an unequal corresponding number of protons and neutrons in their respective nucleus, and the odd-numbered element 7 contradicts the pattern of nucleonic inequality by having an equal number of protons and neutrons in its nucleus.

6. The apparatus of claim 5 further comprises the general divisions of the pattern of anomalies in the baseline of the first twenty representative elements, whereby the nine elements 2, 6, 7, 8, 10, 12, 14, 16, 20 of nucleonic equilibrium, and the eleven elements of nucleonic inequality, elements 1, 3, 4, 5, 9, 11, 13, 15, 17, 18, 19, physically and visually process and determine sub-patterns of symmetry in relation in determining the characteristics and properties of the elements on the neutronic periodic table of the elements

7.- The apparatus of claim 3 further comprises the neutronic schema device that contains a physical and visual processing and displaying of the elements according to alternating columns of odd-numbered elements and even-numbered elements, thereby defining patterns of symmetry and asymmetry in relation to indicia on the elemental sectors in terms of low and high values for stable isotopes.

8. The apparatus of claim 3 further comprises the neutronic schema device that contains the pattern of shells of the electronic configuration of the elements wherein divisions among the shells and sub-shells begin and end in relation to the anomaly elements, 4, 7, and 18, with the first division of shells beginning on element 3 immediately adjacent and prior to element 4; with the second division of shells commencing on element eleven the midpoint of the twenty-element baseline apparatus; with the third division of shells beginning on element 19, one element immediately after anomaly 18; with the fourth division of shells beginning on element 37, one element immediately before the column of anomaly element 18; with the fifth division of the shells beginning on element 57, one element immediately before the column of anomaly element 18; with the sixth division of shells beginning on element 87, which lies precisely on the column of anomaly element 7; whereby the entire pattern of the commencement elements goes from element 3 through element 87, and the sub-pattern is identified as of elements 7, 37, 57, 87 on the neutronic periodic table of elements.

9. The apparatus of claim 5 further comprises the neutronic baseline device of the anomalies of elements 4, 7 and 18 whereby the pattern of nucleonic equilibrium the odd-numbered element 7 and the pattern of nucleonic inequality define patterns of symmetry and asymmetry in the quantitative and qualitative data of physics and chemistry that determine the characteristics and properties of the elements related to the Lithium group, the Boron group, the Carbon group, the Oxygen group, the Chlorine group and the Potassium group, inasmuch as said groups of elements lie adjacent to the anomaly elements 4, 7, and 18, whose groups are respectively the Beryllium group, the Nitrogen group and the Argon group, upon the neutronic schemata, where said patterns of symmetry and asymmetry within the referenced groups begin or end on rows and columns of elemental sectors that are adjacent to the anomaly elements 4, 7 and 18.

10. The claim 9 further comprises the schema apparatus of the projection of the basic 120-element schema to include schemata of the neutronic periodic table of elements 1 through 168, elements 1 through 216, and elements 1 through 504, with all intermediate elements thereof, in which the cycle termination points of the projected 166-168 schema device, the 216-218 schema device and the 502-504 schema device border on or adjacent to either side of the columns of the anomaly elements 4, 7 and 18, whereby elements 502 and 504 lie on either side adjacent to the column of anomaly element 4; whereby elements; whereby elements 166 and 168 lie on either side adjacent to column of anamoly element 7; whereby element 216 lies two elemental sectors before and element 218 lies properly on the column of anomaly element 18.

11. The claim of 3 further comprises the processing and displaying of physical and chemical data on the neutronic schema device whereby the neutron count of each element is thereby divided by the corresponding protonic count or atomic number of each element, whereby the indicia resulting on the elemental sectors contains patterns incremental tendencies in the data by groups of elements for each column which define the characteristics and properties of the elements in patterns, in which elements 3 and anomaly element 4 present breaks in the incremental tendencies by column, and in which elements 21 through 80 inclusively contain incremental tendencies by columns, with one exception in element 43, thereby confirming the division of the elements into groups according to the neutronic count as defined in the baseline of the first twenty elements.

12.- The claim of 3 further comprises the processing and displaying of physical data on the neutronic schema apparatus regarding the coherent scattering length of the atoms of the elements whereby the indicia of quantitative data on the elemental sectors defines the two rows of elements 21 through 60 with an incremental tendency between said two rows, and whereby the two rows of elements 61 through 100 define an incremental tendency between said two rows, thereby confirming the neutronic periodicity division by groups of twenty elements along the horizontal axis of the neutronic periodic table of the elements, and whereby the exceptions to the incremental tendencies exist on or adjacent to the columns of anomaly elements 4, 7, and 18; wherein the data sets are

13. The claim of 3 further comprises the processing and displaying of physical data in terms of centrosymmetries on the neutronic schema apparatus regarding, for example, bond strengths in diatomic molecules, whereby a pattern of centrosymmetry may be seen in the quantitative data referring to the first twenty elements, inasmuch as elemental sectors 3 through 8 register a data set of indicia of 84, 107, 173, 256, 149, 18.8, and elemental sectors 12 through 17 register a data set of indicia of 94, 120, 192, 144, 124, 66, with perceived central symmetries gravitating towards element 6 (value 256) and element 14 (value 192).

14. The claim of 2 further comprises the processing and displaying of physical and chemical data on the neutronic schema apparatus regardingfor example, neutron resonance integral, which confirms the twenty-element division for the neutronic periodicity in that it serves as an example of a pattern of centrosymmetry within a particular period, regarding elements 61 through 80, period IV, whereby element 62 of neutron resonance integral 1.4 in relation to element 80 of neutron resonance integral 87 points to a perceived centrosymmetry in relation to element 70 with neutron resonance integral of 50.

15. The claim of 2 further comprises the processing and displaying of physical and chemical data on the neutronic schema device whereby the neutronic periodicity is confirmed in the symmetry among the different elements of the traditional classification of the elements, whereby, for example, the Alkali Metals Family, elements 3, 11, 19, 37, 55, 87, 119, reflects a pattern of symmetry, whereby elements 3 through 19 establish the outer limits of the periodic function of this family on the first period of elements on the neutronic schema device, whereby element 37 lies precisely at the midpoint between elements 19 and 55; whereby element 55 lies precisely at the midpoint of elements 11 and 19; whereby element 87 lies precisely at the midpoint between elements 3 and 11; whereby element 119 lies along the column of element 119, thus terminating the periodic function of this family on the neutronic schema device.

16. The claim of 5 further comprises the processing and displaying of physical and chemical indicia on the neutronic schema device whereby the nucleonic inequality of anomaly elements 4, 7, 18 confirms the definition of characteristics and properties of the elements in relation to the transition elements, whereby anomaly element 4 determines in part transition element 44 (followed by elements 45, 46); whereby anomaly element 7 determines in part transition element 27 (preceded by element 26 and followed by element 28); whereby anomaly element 18 determines in part element 78 (preceded by elements 76 and 77), all of which confirms a physical and visual symmetry of the anomaly elements 4, 7, 18 in relation to the characteristics and properties of the third transition elements as cited.

17. The claim of 1 further comprises the neutronic schema device whereby the neutron count of elements 21 through 85 may be determined as of the triad element relationship that takes the sum of the neutron count of two alternating elements on the same column and divides that sum by 2 in order to obtain an approximate neutron count number for the third intermediary element of those two elements on the same column, thereby establishing newly perceived relationships among the elements in the determination of their characteristics and properties, which confirms the concepts of neutronic periodicity and nucleonic equilibrium as established by the invention of the neutronic periodic table of the elements.
